(19) United States
(12) Patent Application Publication
(10) Pub. No.: US 2005/0044130 A1
(43) Pub. Date: Feb. 24, 2005

(54) Method for optimizing resources in radio system, and radio system

(76) Inventors: Eero Sillasto, Helsinki (FI); Outi Hiironniemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/681,738

(22) Filed: Oct. 8, 2003

(30) Foreign Application Priority Data
Oct. 8, 2002 (WO) PCT/FI02/00788

(51) Int. Cl. G06F 15/16

(52) U.S. Cl. 709/200

(57) ABSTRACT

The invention relates to a radio system and a method for optimizing resources in a radio system. The method comprises: transferring transport network information about traffic in a transport network of the radio system to a radio network of the radio system, the transport network connecting network elements of the radio network and the radio network to a core network of the radio system; a serving network element of the radio network routing a telecommunications connection of user equipment via the serving network element to the core network. The method further comprises adjusting between the serving network element and the user equipment the telecommunications connection of the user equipment, based on the transport network information.

### FIELD

The invention relates to a method for optimizing resources in a radio system, and to a radio system.

### BACKGROUND

The demands and requirements for the capacity and resources of the mobile communication systems are increasingly tightening with the need for transferring large amounts of data over wireless communications systems and with an increasing number of users and density of the mobile equipment. With the evolving new technologies it has been proposed that future wireless communication networks should use several types of radio access technologies instead of just one type of technology. Technologies such as WCDMA (Wideband Code Division Multiple Access), GSM/EDGE (Global System for Mobile Communication/Enhanced Data Rates for Global Evolution) or the like are already in use worldwide or under constant development. In the near future, wireless communication networks and wireless user equipment will also increasingly support Internet protocol (IP) based technologies. With the use of different technologies, the network as a whole can take advantage of coverage and capacity characteristics of the different technologies. Managing quality of service (QoS) in a network without wasting resources will be one of the critical demands. However, all this causes new demands for optimizing the network resources and their usage.

Communication networks that use packet switched transport can be implemented for example as IP based packet transport networks. An IP packet comprises the information about the packet's destination together with its origin, which makes the packet easily routable. The destination address of the IP packet causes specific routing decisions in routers, through which the packet travels on route to its destination. In circuit switched networks, the content is unaware of its destination, and the network reserves the connection that reserves network capacity as long as the connection lasts. Routing performs well for file transfer, but also for real time traffic, such as voice and video telephony, as long as there is enough network capacity available and the quality of service (QoS) is taken care of.

Problems arise when the communication network is congested, for example part of the communication network becomes overloaded, or is predicted to be congested. Congestion can occur if, for example, the routers or other network elements receive data faster than the data can be forwarded from the router. If the traffic is allowed to flow freely to the transport part, for example the IP transport of the mobile network, like on the Internet, especially the thin transport part close to the base stations may become congested. Congestion may be increased by link failures, which lower the transport capacity. The situation can be deteriorated even further by the use of soft handovers (SHO), which reserve transport capacity.

In prior art it has been suggested that when destination routes are congested, data packets are either dropped or put on hold. Packets being queued at buffers in the communication system can be dropped to make room for arriving packets. New packets can be prevented from entering the congested part of the communication system until there is room for new data. However, these techniques cause problems, such as dropped data or delay, and variation of delay that degrade the quality of service and that therefore are unwanted, especially in real-time telecommunication services.

From the coverage point of view, it may be necessary to build more radio capacity than there is transport capacity on the links close to the base stations. However, this may even increase the possibility of ending up in a congested situation where e.g. handover from one cell to another would be sensible from the radio point of view but not from the transport point of view. Especially in WCDMA based networks the soft handover load is problematic. In current systems the radio resource management (RRM) of the network responsible for handover control performs independently and accepts practically all changes in the amount of soft handover connections, i.e. SHO legs causing heavy variations in the soft handover load. All this may lead to a situation where it may be necessary to build more transport capacity to be able to handle the traffic coming from the radio network. This is problematic, since building of new network resources is expensive.

### BRIEF DESCRIPTION

The present invention seeks to provide an improved method for optimizing resources in a radio system.

As an aspect of the invention a method is provided for optimizing resources in a radio system, the method comprising: transferring transport network information about traffic in a transport network of the radio system to a radio network of the radio system, the transport network connecting network elements of the radio network and the radio network to a core network of the radio system; a serving network element of the radio network routing a telecommunications connection of user equipment via the serving network element to the core network; and adjusting between the serving network element and the user equipment the telecommunications connection of the user equipment, based on the transport network information.

As an aspect of the invention a method is provided for optimizing resources in a radio system, the method comprising: transferring transport network information about traffic in a transport network of the radio system to a radio network of the radio system, the transport network connecting network elements of the radio network and the radio network to the core network of the radio system; and adjusting (504) a soft handover of a telecommunications connection between a base station of the radio network and user equipment, based on the transport network information.

As an aspect of the invention a radio system is provided, comprising a core network, a radio network connected to the core network, for providing a telecommunications connection for user equipment, the radio network comprising network elements, one of the network elements being configured to act as a serving network element that routes the telecommunications connection of the user equipment via the serving network element to the core network; a transport network for connecting the network elements of the radio network and connecting the radio network to the core network, and receiving means for receiving transport network information on traffic of the transport network; and the radio system further comprises adjusting means connected to the receiving means for adjusting between the serving network element and the user equipment the telecommunications connection of the user equipment, based on the transport network information.

As an aspect of the invention a radio system is provided, comprising a core network, a radio network connected to the core network, for providing a telecommunications connection for user equipment; the radio network comprising network elements; a transport network for connecting the network elements of the radio network and connecting the radio network to the core network, and receiving means for receiving transport network information on traffic of the transport network; and the radio system further comprises adjusting means connected to the receiving means for adjusting a soft handover of the telecommunications connection between a base station of the radio network and the user equipment, based on the transport network information.

Other embodiments of the invention are disclosed in the dependent claims.

The invention provides several advantages. The invention makes it possible for the radio system to take the transport load situation into account when optimizing resources of the radio system. An advantage of the invention is that the transport resources need not be dimensioned according to the worst case. Therefore cost savings can be achieved in the building of network resources as the need for new network resources decreases.

An advantage of the invention is that the extra load due to the soft handovers can be adjusted and minimized in congested situations or when congestion is predicted, e.g. during busy hours.

Another advantage is that the networks can better adapt to the load changes without drastic actions such as dropped data that decreases the quality of service. Furthermore, when data does not have to be dropped in the most congested links, the dropped data does not load the other links and unnecessarily utilise transport resources and degrade the quality of other traffic.

Another advantage is that the network resources can be utilised more efficiently, as the access transport network does not act as a limiting factor. Thus there is no need for overdimensioning of the access transport network either.

Another advantage of the invention is that oscillations in the traffic mixture can be reduced. A more constant type of traffic mixture is an advantage, since for example in the routers parameters are adjusted to a certain type of traffic mixture.

### LIST OF FIGURES

In the following, the invention will be described in greater detail with reference to the preferred embodiments and the accompanying drawings, in which

FIG. 1 shows an example of a radio system;

FIG. 2 shows an example of a general protocol model for a radio access system;

FIG. 3 shows another example of a radio system;

FIG. 4 is a flow chart illustrating a method for managing radio resources in a radio system;

FIG. 5 is a flow chart illustrating another method for managing radio resources in a radio system;

FIG. 6 shows an example of the transport load reported to a radio network.

FIG. 7 illustrates an example of the use of the method for optimizing resources; and

FIG. 8 shows an example of soft handover load behaviour in a radio cell.

### DESCRIPTION OF EMBODIMENTS

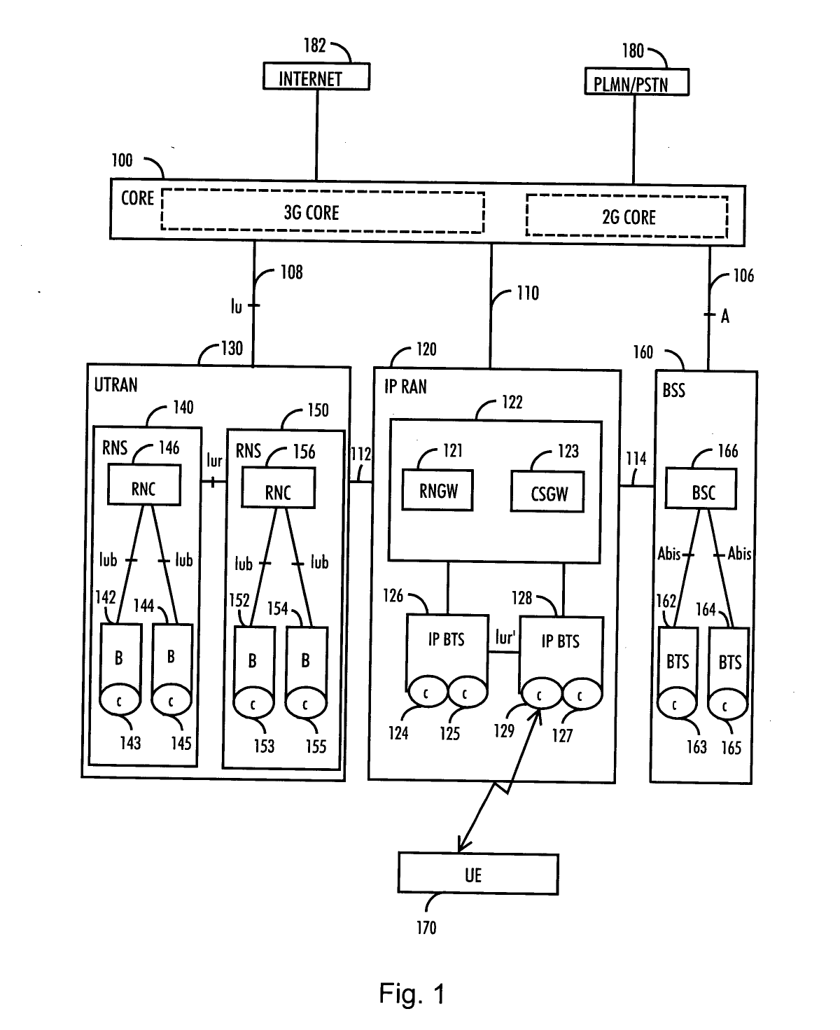

Referring to FIG. 1, a radio system is described as an example of a system to which embodiments of the invention can be applied. In FIG. 1, the embodiments are described in a simplified radio system, which comprises the main parts of a radio system: a core network (CN) 100, a radio access network 120, 130, 160, and user equipment (UE) 170.

FIG. 1 shows the general architecture of an evolutionary 3G radio system using different technologies and interoperation of different generations of radio access networks, where network elements from the second, 2.5 and third generations coexist. In the description, the radio system of the second generation is represented by the GSM (Global System for Mobile Communications), the 2.5 generation radio system being represented by a radio system which is based on the GSM, uses the EDGE technique (Enhanced Data Rates for Global Evolution) for increasing the data transmission rate, and can also be used for implementing packet transmission in the GPRS system (General Packet Radio System). The third generation radio system is represented by a radio system that is known at least by the names IMT-2000 (International Mobile Telecommunications 2000) and UMTS (Universal Mobile Telecommunications System).

The core network 100 of the radio system is connected to the external networks 180, 182. The external networks 180, 182 are represented by a public land mobile network PLMN 180 or a public switched telephone network PSTN 180, and the Internet 182.

The Base Station Subsystem (BSS) 160 based on the GSM comprises a base station controller (BSC) 166 and base transceiver stations (BTS) 162, 164. The base station controller 166 controls the base transceiver stations 162, 164. The interface 106 between the core network 100 and the BSS 160 is called an A interface. The interface between the BSC 166 and BTS 162, 164 is called an A-bis interface. In principle, the devices implementing the radio path and their functions should be located in the base transceiver station 162, 164 and the management devices in the base station controller 166. The implementation may naturally deviate from this principle. As is known to a person skilled in the art, a radio system can comprise several base station subsystems 160 not described in FIG. 1 for the sake of clarity.

The UMTS Radio Access Network (UTRAN) 130 comprises radio network subsystems (RNS) 140, 150. Each radio network subsystem 140, 150 comprises radio network controllers (RNC) 146, 156 and nodes B 142, 144, 152, 154. Node B is rather an abstract concept, which is frequently replaced by the term ‘base station’. The interface between different radio network subsystems RNS 140, 150, or more specifically between the radio network controllers (RNC) 146, 156, is called lur. In the UMTS, the interface between the core network 100 and the UTRAN 130 is called an lu interface 108. The interface between the RNC 146 and the node B 142, 144 is called an lub interface. In respect of its functionality, the radio network controller 140 approximately corresponds to the base station controller 166 of the GSM system, and the node B 142, 144 corresponds to the base station 162, 164 of the GSM system. Solutions where the same device functions both as the base station and as the node B are also available, i.e. the device can simultaneously implement a TDMA and a WCDMA radio interface.

The radio system may also use an IP technology based radio access network, i.e. an IP RAN (Internet Protocol Radio Access Network) 120. FIG. 1 shows the IP RAN 120 as an example of a radio access network (RAN) to which the embodiments can be applied. Since the IP technology based radio access networks and their architecture are being continuously developed, the IP RAN 120 of FIG. 1 shows an examplanary architecture describing some of the main functionalities of such an IP technology based RAN, and the implementations may vary. The IP RAN 120 described in FIG. 1 is a radio access network platform based on IP-technology that also enables interoperation with other, more conventional radio network access technologies and networks, such as the UTRAN (UMTS Radio Access Network), BSS (Base Station Subsystem) used in GSM (Global System for Mobile Communications) or GERAN (GSM EDGE Radio Access Network). The IP RAN is connected to the UTRAN 130 with an interface 112, to the BSS 160 with an interface 114 and to the core network 100 with an interface 110.

The IP RAN 120 can be described briefly with the following groups of entities described in FIG. 1: the IP base stations (IP BTS) 126, 128, and the IP RAN gateways 122, such as for example a radio access network gateway (RAN Gateway, RNGW) 121, and a circuit switched gateway (CS gateway, CSGW) 123 for the circuit switched traffic. The IP RAN gateways 122 may typically comprise also other elements, such as a RAN access server for controlling access to the network. IP RAN 120 can also comprise other elements, such as servers and routers, not described in FIG. 1.

In the IP RAN 120 most of the functions of the centralized controller (RNC 146 and BSC 166) are planned to be moved to the IP base station 126. In particular, all the radio protocols are to be moved to the IP base station 126. Entities outside the IP base station 126 are needed for example to perform configuration and radio resource (RR) functions, or for interworking with conventional radio access networks or base station subsystems or gateways to the core network 100. However, in more evolutionary architectures RNC or BSC may still be used.

FIG. 1 also illustrates the coverage areas, i.e. cells, of the base stations of the different radio access networks. Cells 143, 145, 153, 155 thus represent the coverage areas of the nodes B 142, 144, 152, 154, and cells 163, 165 represent the coverage areas of the base stations 162, 164. One node B 142, 144, 152, 154 or base station 162, 164 may either serve one cell, as illustrated in FIG. 1, or several cells which in the case of base stations can be sectored cells. An IP base station may also serve several cells. In the figure the coverage area of the IP base station (IP BTS) 126 is represented by cells 124, 125, and the coverage are of the IP BTS 128 is represented by cells 127, 129.

The user equipment (UE) 170 illustrated in FIG. 1 is preferably applicable both to 2G and 3G systems, comprising at least one transceiver for establishing a radio connection to the radio access network 120. Typically, the user equipment 170 is a mobile station, further comprising an antenna, a user interface and a battery. Nowadays various kinds of user equipment are available, e.g. equipment installed in a car and portable equipment. The user equipment 170 can also have properties similar to those of a personal computer or a portable computer. The user equipment 170 is connected to the radio system via the base stations of a radio access network, such as the IP RAN 120, for providing the user of the UE 170 with access to the core network of the radio system using a telecommunications connection. The telecommunications connection comprises a radio connection with a base station and a connection between the base station and the core network.

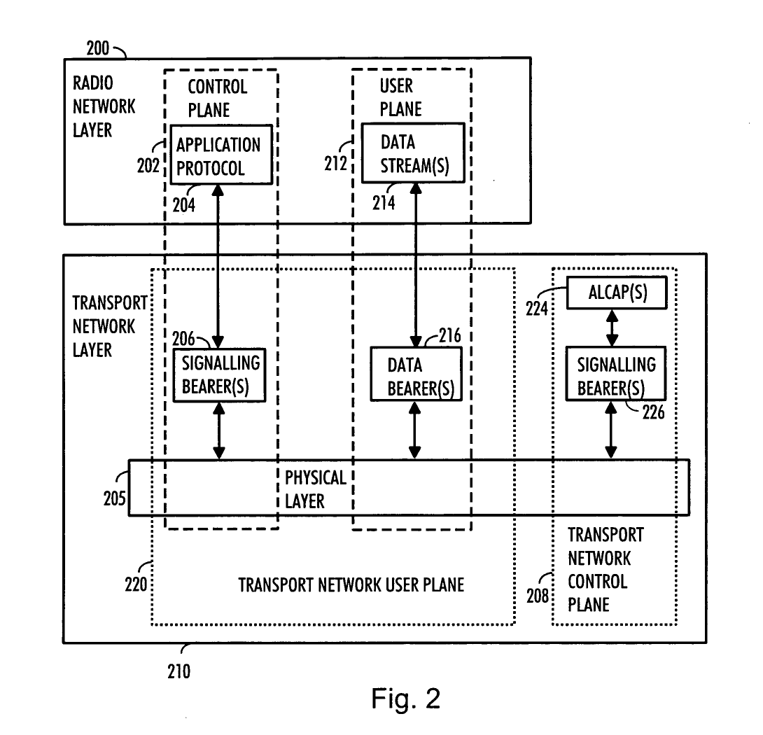

Referring to FIG. 2, a general protocol model for a radio access network is explained, using the UTRAN as an example. Similarly a protocol model for other radio access networks, such as IP RAN, could be described. As described in FIG. 2, UTRAN internal functions and protocols can be classified into two horizontal layers: a radio network layer (RNL) 200, and a transport network layer 210. In the vertical direction the protocol model comprises three planes, a (radio network) control plane 202, a (radio network) user plane 212 and a transport network control plane 208. The control plane 202 and user plane 212 of the radio network layer 200 are conveyed via the transport network layer using the transport network user plane 220. FIG. 2 illustrates the application protocols 204 and the data streams 214 in the radio network layer 200, and the signalling bearers 206, data bearers 216, and the physical layer 205 in the transport network user plane 220 of the transport network layer 210. The signalling bearers 226 and the access link control application protocol (ALCAP) 224 in the transport network control plane 208 of the transport network layer 210 are also illustrated in FIG. 2. The control plane 202 transfers signalling information, and the user plane 212 transfers all information sent and received by the user. The radio network layer 200 includes all the functions and protocols related to radio, i.e. RAN, or cellular specific protocols. The transport network layer 210 represents standard transport technology that has been selected to be used for the RAN, e.g. IP or ATM (asynchronous transfer mode) in the UTRAN or IP in IP RAN. In the transport network layer 210 the signalling bearer is always set up by operation and management actions (O&M). The signalling protocol for ALCAP 224 may be of the same type as the signalling protocol for the application protocol 204 or of a different type. When the signalling bearers are in place, the application protocol 202 in the radio network layer 200 may ask for data bearers 216 to be set up by ALCAP 224, which has all the required information about the user plane technology. Preconfigured data bearers can also be used, similar to the lu interface of the packet-switched side, in which case no ALCAP 224 and therefore neither signalling bearer 226 nor the transport network control plane 208 are needed.

Each layer of the protocol model can be described in terms of logical entities. One physical network element may include more than one logical entity for each layer. Further information on radio telecommunications systems can be found in the literature and standards in the field.

Radio systems, for example systems that use the UTRAN or IP RAN as their radio access system, typically have two basic logical parts for handling the user plane traffic: a radio communications related part and a transport related part. The radio related part comprises for example radio resource management (RRM), radio interface, the lub interface, and radio related protocols, such as RRC (Radio Resource Control), RLC (Radio Link Control) and MAC (Medium Access Control). The RRM comprises algorithms such as handover control, power control, admission control (AC) and packet scheduling, and code management. The transport related part comprises the selected transport technology and its controlling functions. The selected transport technology is, for example, IP based in the IP RAN, and IP or ATM (Asynchronous Transfer Mode) based in the UTRAN.

As the radio resources are expensive, the radio related part of the radio access network tries to optimise their utilisation. There are many methods available for the controlling function of all of the radio related control. For example an entity called the common resource management server (CRMS) can be used for the management of radio resource control. In this application the term ‘radio manager’ (RM) is used for the controlling function of all of the radio related control.

The transport related part of the radio access network tries to optimise the transport resources and controls their usage. For example a method called differentiated services (DiffServ) can be used to guarantee some level of QoS (quality of service) for the different types of traffic, such as real time or non real time traffic in IP networks. When using differentiated services the data packets are marked with information about the content of the packet in terms of importance and delay sensitivity. In this application, the term ‘transport manager’ (TM) is used for the controlling function of all of the transport related control. It is also assumed that the TM has information on the load of the transport network, and preferably also on the topology of the transport network.

The radio communications related part and the transport related part of the radio system are traditionally quite independent and make their decisions independently. These decisions, however, affect the other part and its functionality. The radio manager (RM), for example, makes decisions concerning the usage of soft handovers (SHO) in the telecommunications connection between user equipment and the base station. These decisions, may however, heavily increase the load in the transport network.

The handover function is one of the most important ways to implement user mobility in a radio network. Maintaining a traffic connection with moving user equipment is possible using handovers, where the main idea is, as the user equipment moves from the coverage area of one cell to another, to set up a new connection with a target cell and release the connection with the old cell.

There are several reasons for activating a handover. The basic reason for a handover is that the radio connection no longer fulfils the set criteria, such as signal quality, user mobility or traffic distribution. A signal quality handover is made when the quality of the radio signal deteriorates below defined parameters. The deterioration is detected by the signal measurements carried out by the user equipment or base stations.

A traffic distribution handover occurs when the traffic capacity of a cell has reached the maximum or is approaching it. In a situation like that, the user equipment near the edge of the cell with a high load may be transferred to a neighbouring cell with a smaller load.

Handovers (HO) can be categorised as hard handovers (HHO), soft handovers (SHO), and softer handovers. In a hard handover the old connection is released before making a new connection. In an inter-frequency hard handover the carrier frequency of the new radio access connection is different from the old carrier frequency of the user equipment, and in an intra-frequency handover it is the same as the old carrier. An inter-frequency handover can be used if different carriers are allocated to radio network cells, for example between macro cells and micro cells that use different carriers in the same coverage area. Furthermore, inter-frequency handovers may happen between two different types of radio access networks, for example between the UTRAN and GSM or between IP RAN and GSM. These can also be called inter-system handovers, or inter-RAT (radio access technology) handovers which are inter-frequency handovers. Inter-system handovers are possible only if they are completely supported by the user equipment as well.

In a soft handover the user equipment establishes a new connection to the network before the old connection is released. The UE collects measurement information in an active set, which is a list of base stations, or more specifically, radio cells through which the UE has simultaneously connection to the RAN, for instance the UTRAN or the IP RAN. The active set is thus a list of cells which meet the criteria set for a handover. For example in WCDMA systems most handovers are intra-frequency soft handovers, where the neighbouring base stations involved in the handover transmit using the same frequency. Soft handover is performed between two radio cells that belong to different base stations. However e.g. in UTRAN, the cells do not necessarily belong to the same RNC, but the RNC involved in the soft handover is responsible for coordinating the execution of the soft handover over the lur interface. With circuit switched calls the user equipment performs soft handovers almost all the time if the cells in the radio network are small. The simultaneous connections between the UE and the network are called soft handover legs (SHO leg). A soft handover leg is a connection comprising a radio connection between the UE and a base station and a possible transport connection between the base station and a serving network element that routes the connection of the UE via the serving network element to the core network.

There are also several variations of soft handovers, e.g. softer and soft-softer handovers. In a softer handover a new signal is either added or deleted from the active set, or replaced by a stronger signal of another sector of the same base station. The term ‘soft-softer handover’ is often used when a soft and a softer handover occur simultaneously.

A basic handover process typically comprises three main phases called a measurement phase, decision phase and execution phase. The network manages all types of handovers. For this purpose the network makes measurements in uplink connections and receives the UE measurements results on downlink connections. User equipment constantly measures the signal strength of the neighbouring cells for handover purposes and during the connection, and reports the results to the network, to the radio resource control (RRC), which for example in UTRAN is located in the RNC. The cells to be measured can be divided into three different cell sets: the active, the monitored and the detected set. Each set performs measurements in the cells according to their own requirements.

The UE measurements may comprise for example intra-frequency measurements, such as measurements on the strength of the downlink physical channels for signals with the same frequencies, traffic volume measurements, such as measurements of the uplink traffic volume, quality measurements, such as measurements of quality parameters e.g. the downlink transport block error rate, and internal measurements, such as measurements of user equipment transmission power and user equipment received signal level. The UE measurement events may be triggered based on criteria such as change of the best cell, changes in the signal-to-interference ratio (SIR), periodical reporting or time-to-trigger or changes in the primary common pilot channel (CPICH) signal level. The UE collects measurement information in the active set. When the signal strength of a BTS transmission exceeds the addition threshold in the UE, the BTS is added to the active set and the UE enters to an SHO if it is not already there. The UE does not add or remove base stations in its active set independently, but the network requests modifications for the active set through signalling mechanisms.

The measurements reported by the UE and BTS and the criteria set by the handover algorithm form a basis to the handover decision-making. The handover algorithms are not standardised, but more of an implementation-dependent type and can be used rather freely. General principles of a handover algorithm can be explained using an example where the decision-making criteria of the handover algorithm are based on the pilot signal strength reported by user equipment. In the examplanary handover algorithm, the following terms and relative parameters are used: the active set, an upper threshold, a lower threshold and a handover margin. Typically these parameters are relative figures, e.g. in relation to signals of other base stations. The upper threshold is the level at which the sum of the signal strengths of the cells in the active set of the connection is at the maximum acceptable level to satisfy the required QoS. Accordingly, the lower threshold is the level where the sum of the signal strengths of the cells in the active set of the connection is at the minimum acceptable level in respect to the requested QoS, i.e. the signal strength of the connection should not fall below the lower threshold. The term ‘handover margin’ is in this example a pre-defined parameter, set at the point where the signal strength of the neighbouring cell starts to exceed that of the current cell by a certain amount and/or for a certain time.

In the example we assume that a UE camping in cell A is moving towards a neighbouring cell B, and the pilot signal A, to which the UE currently has a connection, deteriorates as the UE moves, and approaches the lower threshold. This may result in handover triggering during the following three phases: The strength of signal A reaches the lower threshold. Based on the UE measurements the radio network notices that neighbouring signal B with adequate strength for improving the quality of the connection is already available. The radio network adds signal B to the active set, after which the UE has two simultaneous connections to the radio access network and can benefit from the summed signal of signal A and signal B., i.e. in the example, the lower threshold can be called the addition threshold. As the UE moves, the quality of signal B starts to become better than the quality of signal A and the radio network starts the handover margin calculations. Finally the strength of signal B reaches or exceeds the defined lower threshold, i.e. the strength of signal B is adequate to satisfy the required QoS of the connection. On the other hand, the strength of the summed signal passes the upper threshold and starts to cause additional interference to the system. As a result of this the radio network deletes signal A from the active set, i.e. in the example, the upper threshold can be called the drop threshold. The active set typically ranges from 1 to 3 signals, but its size may vary. In the example above, the size of the active set varies between one and two.

Generally the drop threshold parameter set by the network is always lower than the addition threshold, preventing the premature removal of a radio cell from the active set. The exact value of the drop parameter is a system performance parameter, and it can be set dynamically.

As the direction where the UE moves randomly varies, the UE may move back towards the original cell (cell A in the example) instantly after the first handover. This leads to a so-called ping-pong effect where the same cell is repeatedly added and removed from the active set. This is harmful to the system capacity and overall performance. These undesired handovers that cause additional signalling load to the radio access network can be avoided with the use of handover margins or hysteresis parameters. The effect can also be avoided with the use of timers. A drop timer may be started in the network when a signal strength value drops below a set treshold value. If the signal strength value of a base station stays below the set treshold until the time of the timer expires, the base station is finally removed from the active set. To prevent the ping-pong effect the time of the timer must be long enough.

The radio access network uses both the add and drop threshold to determine when active set update is needed. The thresholds are applied to UE measurements, and the UE must use the current thresholds to trigger the sending of the measurement reports to the radio access network. A measurement report containing the latest results is sent to the network when a monitored cell exceeds the RAN-defined add threshold. Depending on the control algorithm, the network may then send an active set update message to the UE. The control algorithm comprises also other parameters and considerations than the add threshold. For instance, a cell may be so overloaded that new connections are not allowed in the cell.

The cells that have been identified as possible candidates for a handover but not yet have been added to the active set are included in the monitored set. The RAN indicates these cells to the UE in a neighbour cell list, and the UE has to monitor these cells according to given rules. If a cell in the monitored set exceeds the add threshold, a measurement report will be triggered. The detected set contains all the other cells found by the UE while monitoring, and cells that are not included in the neighbour cell list

The RRC layer is responsible for maintaining the connection between the UE and the network if a UE moves from one cell to another. A handover decision is made in the RAN RRC, and it is based on, among other things, the UE measurements. SHOs are managed with active set update messages sent by the network, i.e. the UE should not update the active set by itself, but according to these messages. A UE in an SHO always consumes more network resources than a UE with a normal single connection to the network. Therefore it is the network that decides which UEs need the additional gain from SHO.

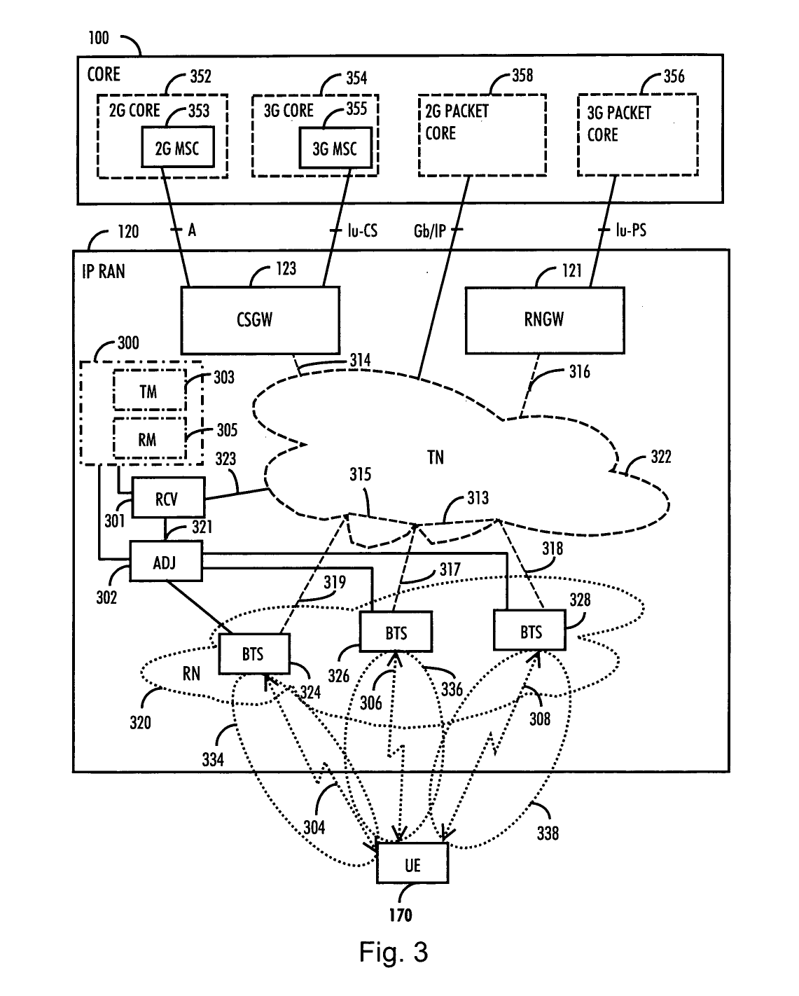

FIG. 3 illustrates a manner of optimizing resources in a radio system. The embodiment is described in a simplified radio system, using an IP RAN based system as an example. However, the embodiments are not restricted to the systems given as examples but a person skilled in the art may apply the solution to other radio systems or their combinations provided with necessary properties.

The radio system of FIG. 3 comprises a radio access network in this case an IP RAN 120, but the radio access network could also be some other radio access network, for example UTRAN, described in FIG. 1.

The radio system comprises at least one unit of user equipment 170. The IP RAN 120 of FIG. 3 comprises a radio network 320 for providing a telecommunications connection to the user equipment 170 and a transport network 322 for connecting the network elements of the radio network 320 and connecting the radio network 320 to the core network 100 of the radio system. The telecommunications connections are established by the user equipment and base stations which communicate with each other on a radio connection, i.e. calls or data transmission connections between different UEs are established via base stations. The radio cells created by the base stations usually overlap to some extent to provide extensive coverage. The radio network 320 comprises base stations 324, 326, 328, which, in the case of IP RAN 120, are IP base stations. The first base station 326 provides the user equipment 170 with a radio connection 306 in radio cell 336 for providing it with access to the radio system. The logical function of the radio network 320 is to provide the user equipment 170 with a radio cell 336, 338, 334 for radio transmission and reception. The logical function of the transport network 322 is to provide the radio cell 334, 336, 338 with a connection to the core network 100. One base station can comprise several radio cells, but these are not described in FIG. 3 for the sake of clarity.

The IP RAN 120 also comprises radio access network gateways 121, 123 that are the access points to IP RAN from the core network and other radio access networks. The radio access network gateways may comprise such gateways as a circuit switched gateway (CSGW) 123 for the circuit switched traffic, and a radio access network gateway (RNGW) 121. The IP RAN can typically comprise also other RAN gateways, such as a radio access network server (RNAS, RAN access server) for controlling access to the radio access network. The transport network 322 is connected via a connection 314 to the CSGW 123 and via a connection 316 to the RNGW 121. Both connections 314 and 316 are part of the transport network 322. In the example of FIG. 3, connections 314, 316 are implemented as IP connections, but their implementation is not restricted to IP; other suitable techniques can also be used.

In the case of UTRAN (see UTRAN 140 and RNS 140, 150 in FIG. 1), the radio access network comprises nodes B connected via the lub interface to an RNC.

The core network 100 described in FIG. 3 may comprise core networks of different generations, such as a 2G core network 352, 3G core network 354, 3G packet core network 356 and 2G packet core network 358. The 2G core network 352 comprises a 2G mobile station controller (2G MSC) 353 connected via interface A to the CSGW 123. The 3G core network 354 comprises a 3G mobile station controller (3G MSC) 355 connected via an lu-CS interface to the CSGW 123. The 3G packet core network 356 is connected via an lu interface to the RNGW 121. The 2G packet core network 358 is connected via a Gp/IP interface to the transport network 322. One of the network elements of the radio network 320 acts as a serving network element that fulfils the serving functionality, in other words routes the telecommunications connection of the user equipment 170 via the serving network element to the core network 100, i.e. it terminates the core network interfaces and RRC (radio resource control). There is always one serving network element for each UE that has a connection to the RAN. In the case of IP RAN this serving network element is a serving base station (serving IP BTS), and in the case of UTRAN a serving radio network controller (RNC). The radio network 320 may also comprise a drifting network element, which in case of the IP RAN is called a drifting IP BTS, and in the case of UTRAN a drifting RNC. The role of the drifting network element is merely to provide the serving network element with radio resources for the UE connection when the connection needs to use the cells controlled by the drifting network element. The serving and drifting network elements may change their location, i.e. a drifting network element may later act as a serving network element and vice versa.

In a radio system a telecommunications connection of UE can be anchored to a network element, for example to a base station of the radio network. The term ‘anchoring’ can be used in IP RAN to describe a situation where the serving IP BTS functions are provided by a BTS not providing radio resources to the UE. In UTRAN the term can be used to describe a situation when a UE has no connections to any cell controlled by the serving RNC.

The radio system of FIG. 3 also comprises a radio manager 305 connected to the radio network 320 for implementing the controlling function of all of the radio related control and for managing the radio resources between the base stations and the user equipment in the radio network. The radio manager 305 is typically configured to receive radio capacity information, which can be indicated as the cell load of the radio cell. The radio manager 305 can, for example, be implemented by one of the RAN common servers, e.g. an entity called a common resource management server (CRMS). However, the implementation of the embodiment is not restricted to the CRMS but the radio manager 301 could be any entity configured to control the radio resources of a radio system.

The radio system of FIG. 3 further comprises a transmission manager 303 connected to the transmission network 322 for implementing the controlling function of all the transport related control and for managing the transport network resources. The transport manager 303 has information on the load of the transport network and on its topology. The transport manager 303 is configured to receive transport load information on the transport network 322 available to the radio cells. The transport manager 303 can, for example, be implemented by an entity called an IP Transport Resource Manager (ITRM), which is introduced in a previous application (PCT/IB02/00919) of the applicant, incorporated herein by reference. The ITMR belongs to the transport network 322 logical architecture and it manages and monitors the resources across the access part of the IP transport network, but not the core network. The implementation of the embodiments are, however, not restricted to the ITRM but the transport manager 303 could be any entity configured to receive information on the transport load and the topology of the transport network 322.

The transport manager 303 and the radio manager 305 could be implemented in a common element, e.g. as parts of a common manager entity 300, but they may also be implemented separately as stand alone elements, e.g. separate servers or as parts or functionalities of other logical entities of the radio access network.

The radio system further comprises receiving means 301 for receiving transport network information on the traffic of the transport network via connection 323, and adjusting means 302 connected to the receiving means by connection 321 for adjusting the telecommunications connection between the serving network element of the radio network and the user equipment, based on the transport network information. In an embodiment the adjusting means 302 adjust a soft handover of the telecommunications connection between a base station of the radio network and user equipment, based on the transport network information received by the receiving means 301.

The receiving means 301 and adjusting means 302 can be implemented as part of the radio manager RM functionalities, e.g. as part of the CRMS functionalities, or part of the transmission manager TM functionalities, e.g. as part of the ITMR functionalities, or their functions could be divided between the RM 305 and TM 303. In this case the TM 303 and RM 305 may be implemented in the same element, or in separate elements, provided that the signalling between the elements is taken care of. The receiving means 301 and adjusting means 302 may also be implemented as parts or functionalities of other logical entities of the radio access network. The receiving means 301 and adjusting means 302 can, for example, be implemented in the IP BTS 324, 326, 328, or in the case of UTRAN in the RNC.

The receiving means 301 receive measurements and reports indicating the transport load of the transport network 322. The transport load may also be indicated as the transport capacity of the transport network 322.

The receiving means 301 indicate the transport load information to the adjusting means 302 to which they are connected. The adjusting means 302 then adjust the telecommunications connection between a serving network element and the user equipment 170, based on the transport network information. Especially, the adjusting means 302 are used to adjust a soft handover of the telecommunications connection between a base station of the radio network and user equipment, based on the transport network information.

FIG. 3 shows a situation where the UE 170 is in a soft handover situation. The user equipment 170 communicates over radio connection 306 with the first base station 326, and the cell 336 is included in the active set of the UE 170. The UE 170 measures common pilots of the first base station 326 and simultaneously also the common pilots of the second base station 324 and the third base station 328. A radio connection 304, 308 is then established also between the UE 170 and BTS 324 and BTS 328 for providing a connection to the core network 100 via these base stations, and the cell 334 and the cell 338 are added in the active set already comprising the cell 336. The simultaneous connections between the UE 170 and the network are called soft handover legs (SHO leg), and they comprise the radio connections 304, 308 between the UE 170 and the base stations 324, 328 and also the transport connections between the base stations 324, 328 and a network element acting as a serving network element, which in the case of IP RAN is a serving IP BTS and in the case of UTRAN a serving RNC. Creating and maintaining of the SHO legs increases the load of the transport network 322. Let us assume that the receiving means 301 receive transport network information on the transport network 322 indicating heavy load or congesting in the transport network 322. This information is indicated to the adjusting means 302. In an embodiment, the adjusting means 302, based on the transport network information, adjust a soft handover of the telecommunications connection between a base station of the radio network and user equipment. When the load in the transport network 322 changes, for example decreases, the receiving means 301 receive information on this, and indicate the information to the adjusting means 302 that take this into account and adjust the soft handover based on the updated transport network information.

In FIG. 3 we further assume that the BTS 326 is a serving network element, in this case a serving BTS 326. The BTS 326 is connected to the transport network 322 via a connection 317, the BTS 324 via a connection 319 and the BTS 328 via a connection 318. The connections 317, 318, 319 belong to the transport network 322. The serving BTS 326 is connected to the BTS 324 with a connection 315 and to the BTS 328 with a connection 313. The connections 313, 315 are also part of the transport network 322 and comprise in practise also the connections 317, 318, 319 from the base stations 324, 326, 328 to the transport network 322, i.e. the connection 313 comprises the connections 317, 318 and the connection 315 comprises the connections 317, 319. The serving BTS 326 takes care of the telecommunications connection of the UE 170 between the serving BTS 326 and the core network 100. The telecommunications connection comprises a radio connection, e.g. the connection 304 to a base station, e.g. the BTS 324, and in IP RAN if the base station 324 is a drift base station, a connection 315 between the drift base station and the serving base station BTS 326, and a connection between the serving base station 326 and the core network 100. In a soft handover situation this telecommunications connection comprises radio connections 306, 304, 308 and connections between the serving BTS 326 and drift BTS 324, 328, i.e. the connection 315 and connection 313 and also the connection between the serving BTS 326 and the core network 100. In the case of UTRAN the serving RNC routes the telecommunications connection of the UE to the core network 100 and the telecommunications connection comprises all the radio and transport connections between the UE 170 and the core network 100.

As we said earlier, the receiving means 323 receive transport network information on the transport network 322 indicating heavy load or congesting in the transport network 322. This information is indicated to the adjusting means 302. In an embodiment, the adjusting means 302 adjust the telecommunications connection between the serving network element and user equipment, based on the transport network information. In our example the adjusting means 302, based on the transport network information, adjust the telecommunications connection between the serving BTS 326 and the UE 170. Again, when the load in the transport network 322 changes, the receiving means 323 receive information on this and indicate the information to the adjusting means 302 that take this into account and adjust the telecommunications connection between the serving network element 326 and the UE 170, based on the updated transport network information.

In an embodiment, when adjusting the telecommunications connection between the serving network element and the user equipment, the adjusting means 302 may adjust a soft handover of the telecommunications connection between a base station of the radio network and the user equipment having a radio connection with the base station, based on the transport network information.

In an embodiment, in order to reduce the active set updates, the adjusting means 302 adjust criteria for a soft handover. This may be done by using the adjusting means 302 to adjust the SHO margins for triggering a soft handover, or alternatively, to adjust the SHO hysteresis limits for triggering a soft handover. More specifically the adjusting means 302 can be used to adjust the SHO criteria by adjusting margins for triggering a soft handover measurement report based on the transport network information, or alternatively, to adjust the SHO hysteresis limits for triggering a soft handover measurement report. In another embodiment, the adjusting means 302 are used to adjust the SHO by keeping the old margins and hysteresis limits, but adjusting the sending of an active set update message to the UE 170. In another embodiment, in order to reduce the active set updates the update message may not be sent even though the UE measurements indicate an update reason. In another embodiment the adjusting means 302 are used to adjust the SHO by adjusting the SHO margins or hysteresis limits for relative signal strength of the telecommunications connection between the base station and the user equipment. The SHO criteria and SHO margins and hysteresis limits for triggering the measurement report may also be adjusted individually for each handover leg.

In an embodiment the adjusting means 302 adjust the number of soft handover legs allowed for UE 170, i.e. the soft handover legs are allowed to be created only between certain number of base stations or cells. In an embodiment the adjusting means 302 restrict the number of SHO legs to two SHO legs.

In another embodiment the adjusting means 302 adjust the permissibility of a soft handover with a certain service, i.e. soft handovers may not be used with all services. For example soft handovers may not be allowed to be used with any non real time (NRT) service, or are allowed to be used only for some NRT services. The restrictions may be based on the type of the used service, traffic class or priority of the connection. For example, it may be allowed to use soft handover only with so called gold users, and not allowed for silver or bronze users.

In an embodiment, the adjusting means 302 adjust the usage of soft handover per base station. In another embodiment, the adjusting means 302 adjust the usage of soft handover per radio cell. This may be done for example by setting a limit for SHO usage for certain or all radio cells or base stations. The limit may be for instance a maximal amount of traffic (kbps) from a cell or a BTS.

In an embodiment, the adjusting means 302 adjust the bitrate allocated for a bearer between network elements of the radio network. Typically, when adjusting the allocated bitrate over the lur or lub interfaces in UTRAN, or over the lur' interface in IP RAN, the adjusting means 302 allocate smaller bitrates for some non-real-time (NRT) services. In an embodiment the allocated bitrates can also be multiplexed, i.e. the allocated bitrate for several bearers is adjusted simultaneously. This can be done by allowing only certain number of bits i.e. a certain bitrate for all bearers or by giving a bigger bitrate for one or a few connections at a time.

In an embodiment the adjusting means 302 adjust the anchoring of the telecommunications connection of the user equipment with a network element of the radio network. In an embodiment the anchoring is limited. In another embodiment, no anchoring is allowed. For example, when the transport network information received via receiving means 301 indicates congestion or heavy load in the transport network, the adjusting means 302 can be used to prohibit the telecommunications connection of the UE 170 to be anchored to a base station, for instance to the BTS 326. This means that the serving functionality may not be anchored to the BTS 326, but the other base stations, e.g. the BTS 328, can act as a serving base station.

The disclosed functionalities can be implemented in the different parts of the radio system by means of software, usually as a processor and its software, but various hardware solutions are also feasible, e.g. a circuit built of logic components or one or more application specific integrated circuits ASIC. A hybrid of these different implementations is also feasible. When selecting the implementation method, a person skilled in the art will consider the requirements set on the size and power consumption of the device, the necessary processing capacity, the production costs and the production volumes.

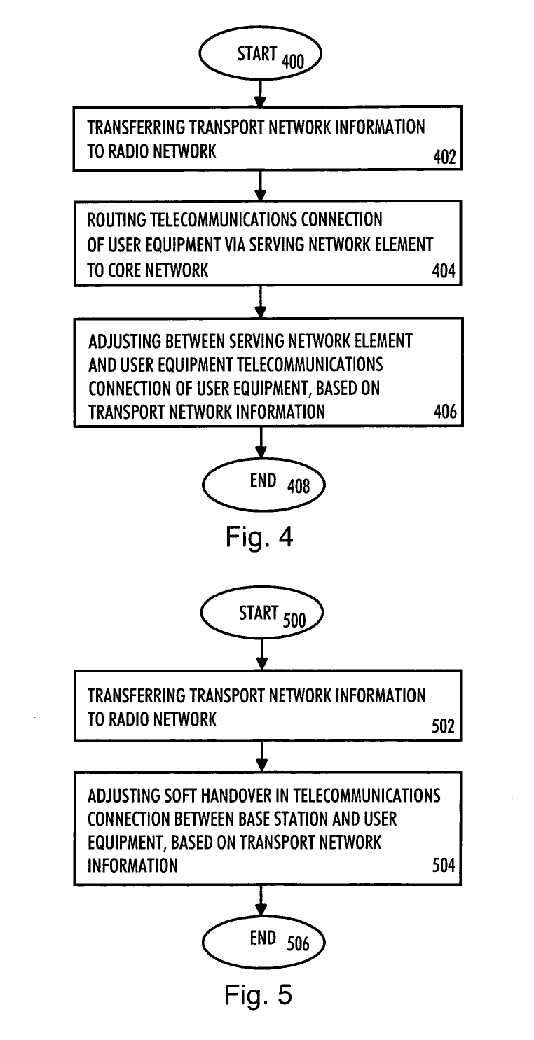

Referring now to the flow chart of FIG. 4, a first method for optimizing resources in a radio system is described.

The method starts in 400. In 402, transport network information about traffic in the transport network of the radio system is transferred to the radio network of the radio system. The transport network connects the network elements of the radio network and the radio network to the core network of the radio system.

In 404 one of the network elements of the radio network acts as a serving network element routing a telecommunications connection of the user equipment via the serving network element to the core network.

In 406, the telecommunications connection of the user equipment is adjusted between the serving network element and the user equipment, based on the transport network information. The method ends in 408.

In an embodiment of the first method, in the adjustment of the telecommunications connection of the user equipment, a soft handover of the telecommunications connection between a base station of the radio network and the user equipment having a radio connection with the base station is adjusted based on the transport network information.

Referring now to the flow chart of FIG. 5, a second method for optimizing resources in a radio system is described.

The method starts in 500. In 502, transport network information about traffic in the transport network of the radio system is transferred to the radio network of the radio system. The transport network connects the network elements of the radio network and the radio network to the core network of the radio system.

In 504, a soft handover of the telecommunications connection between a base station of the radio network and the user equipment is adjusted based on the transport network information. The method ends in 506.

According to the second method, one of the network elements of the radio network may act as a serving network element routing the telecommunications connection of the user equipment via the serving network element to the core network.

We now describe further embodiments, applicable to both of the above methods.

In an embodiment the serving network element is a serving base station or a serving radio network controller.

In an embodiment, the telecommunications connection comprises a radio connection between the user equipment and the serving network element.

In an embodiment, the telecommunications connection comprises a radio connection between the user equipment and a base station of the radio network, and a connection between the base station and the serving network element.

In an embodiment, anchoring of the telecommunications connection of the user equipment with a network element of the radio network is adjusted. In an embodiment the anchoring is limited. In another embodiment, no anchoring is allowed.

In an embodiment, criteria for a soft handover are adjusted. In an embodiment the margins for triggering a soft handover measurement report are adjusted. In an embodiment hysteresis limits for triggering a soft handover measurement report are adjusted. In an embodiment soft handover margins are adjusted. In an embodiment soft handover hysteresis limits are adjusted. In another embodiment margins for relative signal strength are adjusted. In an embodiment hysteresis limits for relative signal strength are adjusted.

In an embodiment, the number of soft handover legs is adjusted. In an embodiment the number of SHO legs is restricted to two SHO legs.

In an embodiment, the permissibility of a soft handover with a certain service is adjusted. In an embodiment soft handovers are not allowed to be used with any non real time (NRT) service, or are allowed to be used only for some NRT services. In the embodiment the adjustment is based on the type of the used service, traffic class or priority of the connection

In an embodiment, usage of soft handover per base station is adjusted.

In an embodiment, usage of soft handover per radio cell is adjusted.

In an embodiment, the bitrate allocated for a bearer between network elements of the radio network is adjusted. In an embodiment smaller bitrates are allocated for some non-real-time (NRT) services. In another embodiment the allocated bitrates can be multiplexed, i.e. the allocated bitrate for several bearers is adjusted simultaneously.

The disclosed methods can be implemented by the radio systems disclosed previously, but also other kinds of radio systems can be used.

The above-mentioned adjustments may be used for the existing telecommunications connections, or only for new telecommunications connections. The adjustments may be used to modify the control function of the connections in user equipment and/or IP BTS or RNC.

The adjustments may be used for telecommunications connections between all or some base stations of the radio system.

The adjustments, especially the adjustments of the SHO and the limitation of the SHO load, are particularly needed when the transport network is very loaded, e.g. during a busy hour. When the transport network is less loaded the need for adjustments is smaller or no adjustment is needed.

The adjustments may be needed temporarily when the network is loaded and the mobility of the UEs is high. In such a case the proportion of the SHO traffic is exceptionally high. As the SHO traffic is classified to be very urgent traffic, a large proportion of it reduces the benefits that can normally be gained by using the differentiated services (DiffServ).

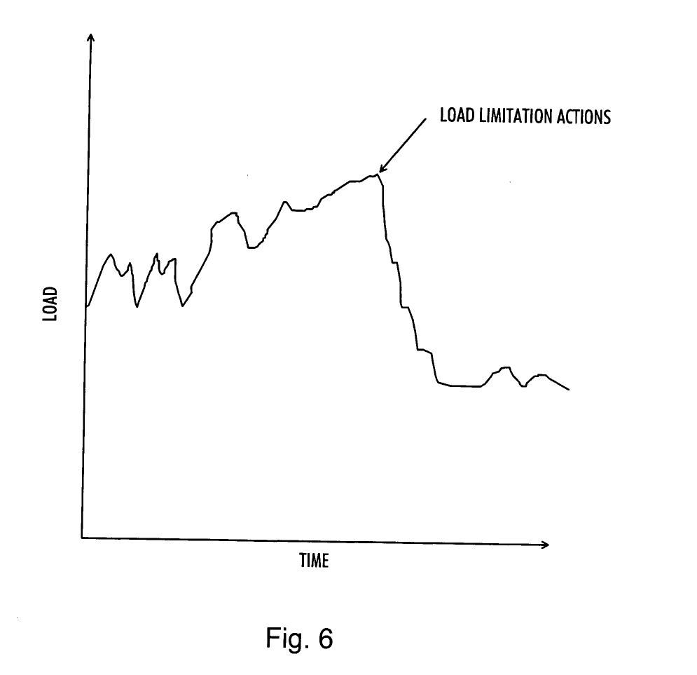

FIG. 6 represents an example of the transport load that receiving means report to adjusting means. As the load increases, the triggering to decrease the SHO load is performed. The load decreases due to these actions. In this context the load may be, for example, a direct measure of the tranport load (kbps), or QoS measurement, like the transport queue length or transport delay.

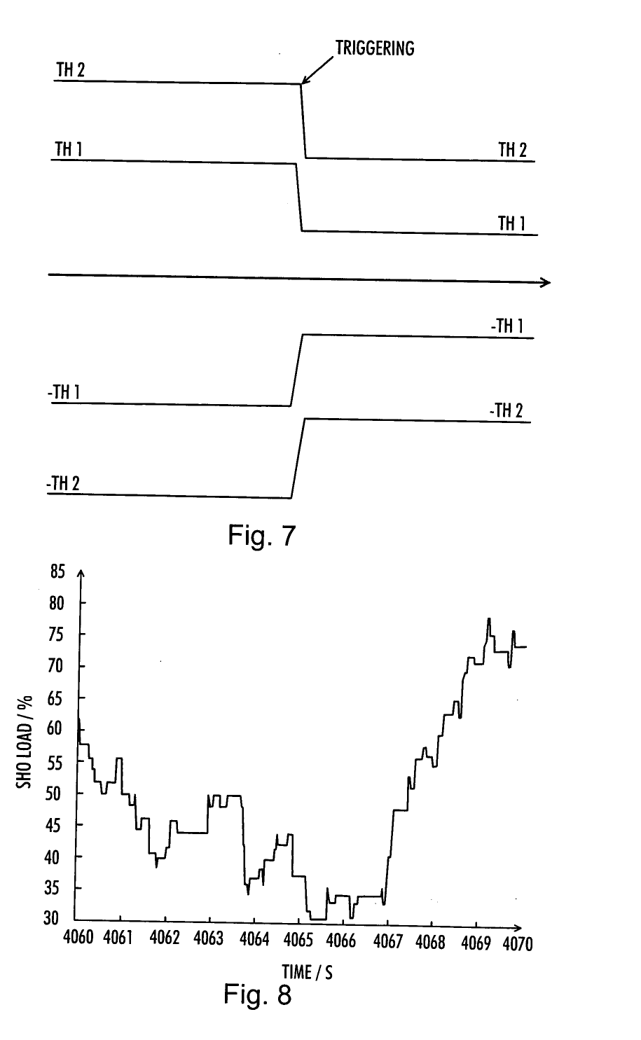

FIG. 7 represents a way to decrease the SHO propability of a connection using the method for optimizing resources. The thresholds TH1 and −TH1 present the thresholds when a new connection is added to an active set, and TH2 and −TH2 present the thresholds when a connection in the active set is removed. The action is to decrease the threshold values as represented in figure. The hysteresis margins may also be decreased (e.g. TH2-TH1).

FIG. 8 represents a simulated SHO load in one cell. The vertical axis represents the SHO load percentage, which in this example is the extra load due the second and third SHO radio legs compared with the case when there is only one radio leg per connection, i.e. there is no SHO. The variation of the SHO load is heavy. In a couple of seconds' time interval, the SHO load may increase or decrease by tens of percents. This kind of fast variations may not be stabilized without actively limiting the SHO traffic. For example, the admission control cannot react as fast. The variations are dependent of the SHO margings, presented in FIG. 7. If TH1=TH2=0 dB, there will be no SHO or SHO load.

Even though the invention is described above with reference to an example according to the accompanying drawings, it is clear that the invention is not restricted thereto but it can be modified in several ways within the scope of the appended claims.

1. A method for optimizing resources in a radio system, the method comprising:
transferring transport network information about traffic in a transport network of the radio system to a radio network of the radio system, the transport network connecting network elements of the radio network and the radio network to a core network of the radio system;
routing, by a serving network element of the radio network, a telecommunications connection of user equipment via the serving network element to the core network; and
adjusting, between the serving network element and the user equipment, the telecommunications connection of the user equipment, based on the transport network information.

2. The method of claim 1, wherein the adjustment a soft handover of the telecommunications connection between a base station of the radio network and the user equipment is adjusted based on the transport network information.

3. A method for optimizing resources in a radio system, the method comprising:
transferring transport network information about traffic in a transport network of the radio system to a radio network of the radio system, the transport network connecting network elements of the radio network and the radio network to the core network of the radio system, and
adjusting a soft handover of a telecommunications connection between a base station of the radio network and user equipment, based on the transport network information.

4. The method of claim 3, wherein one of the network elements of the radio network is a serving network element routing the telecommunications connection of the user equipment via the serving network element to the core network.

5. The method of claim 1 or 4, wherein the serving network element is selected from a group including: a serving base station, a serving radio network controller.

6. The method of claim 1 or 4, wherein the telecommunications connection comprises a radio connection between the user equipment and the serving network element.

7. The method of claim 1 or 4, wherein the telecommunications connection comprises a radio connection between the user equipment and a base station of the radio network, and a connection between the base station and the serving network element.

8. The method of claim 1 or 3, further comprising adjusting at least one element in a group comprising:
anchoring of the telecommunications connection of the user equipment with a network element of the radio network;
an adjustment criteria for a soft handover;
the number of soft handover legs;
the permissibility of a soft handover with a certain service;
usage of soft handover per base station;
usage of soft handover per radio cell, and
bit rate allocated for a bearer between network elements of the radio network.

9. A radio system, comprising:
a core network;
a radio network connected to the core network, for providing a telecommunications connection for user equipment, the radio network comprising network elements, one of the network elements being configured to act as a serving network element that routes the telecommunications connection of the user equipment via the serving network element to the core network;
a transport network for connecting the network elements of the radio network and connecting the radio network to the core network;
receiving means for receiving transport network information on traffic of the transport network, and
adjusting means connected to the receiving means for adjusting, between the serving network element and the user equipment, the telecommunications connection of the user equipment, based on the transport network information.

10. The system of claim 9, wherein the adjusting means is configured to adjust a soft handover of the telecommunications connection between a base station of the radio network and the user equipment, based on the transport network information.

11. A radio system, comprising
a core network;
a radio network connected to the core network, for providing a telecommunications connection for user equipment; the radio network comprising network elements;
a transport network for connecting the network elements of the radio network and connecting the radio network to the core network, and receiving means for receiving transport network information on traffic of the transport network, and
adjusting means connected to the receiving means for adjusting a soft handover of the telecommunications connection between a base station of the radio network and the user equipment, based on the transport network information.

12. The system of claim 11, wherein at least one network element of the radio network is configured to act as a serving network element that routes the telecommunications connection of the user equipment via the serving network element to the core network.

13. The system of claim 9 or 12, wherein the serving network element is selected from a group comprising: a serving base station; a serving radio network controller.

14. The system of claim 9 or 12, wherein the telecommunications connection comprises a radio connection between the user equipment and the serving network element.

15. The system of claim 9 or 12, wherein the telecommunications connection comprises a radio connection between the user equipment and a base station of the radio network, and a connection between the base station and the serving network element.

16. The system of claims 9 or 11, wherein the adjusting means is configured to adjust at least one element in a group comprising:
anchoring of the telecommunications connection of the user equipment with a network element of the radio network, based on the transport network information;
criteria for a soft handover;
the number amount of soft handover legs;
permissibility of a soft handover with a certain service;
usage of soft handover per base station;
usage of soft handover per radio cell, and
bit rate allocated for a bearer between network elements of the radio network.
